(19) United States
(12) Patent Application Publication
(10) Pub. No.: US 2022/0315401 A1
(43) Pub. Date: Oct. 6, 2022

(54) DEF Tank Hydraulic Jack Adapter Plate

(71) Applicant: Francis Pedneau, Phoenix, AZ (US)

(72) Inventor: Francis Pedneau, Phoenix, AZ (US)

(21) Appl. No.: 17/529,789

(22) Filed: Nov. 18, 2021

Related U.S. Application Data
(60) Provisional application No. 63/167,951, filed on Mar. 30, 2021.

(51) Int. Cl. B66F 7/28; B66F 7/16; B66F 3/25; B66F 13/00

(52) U.S. Cl. CPC B66F 7/28; B66F 7/16; B66F 3/25; B66F 13/00; B66F 2700/052

(57) ABSTRACT

The present invention relates generally to a DEF tank hydraulic jack adapter plate. The adapter can be fixedly or removably attached to the top surface of an existing hydraulic jack such that the jack can be used to remove or replace a DEF tank from a diesel vehicle. Accordingly, the adapter secures a tank to the plate body of the adapter via a plurality of frame arms which attach to the vertical plates of the plate body. The adapter ensures the tank is retained upon the adapter and subsequently on the jack.

### CROSS-REFERENCE TO RELATED APPLICATION

The present application claims priority to, and the benefit of, U.S. Provisional Application No. 63/167,951, which was filed on Mar. 30, 2021, and is incorporated herein by reference in its entirety.

### FIELD OF THE INVENTION

The present invention relates generally to the field of hydraulic jacks or other jack assists. More specifically, the present invention relates to a diesel exhaust fluid (“DEF”) tank hydraulic jack adapter plate. The adapter can be fixedly or removably attached to the top surface of an existing hydraulic jack such that the jack or lift can be used to remove or replace a DEF tank from a diesel vehicle. Accordingly, the adapter secures a DEF tank to the plate body of the adapter via a plurality of frame arms which attach to the vertical plates of the plate body as well as the continuous openings of the bracket-like areas of a DEF tank. As such, the adapter ensures the DEF tank is retained upon the adapter and subsequently retained on the jack such that a user need not worry about the DEF tank falling from the jack and becoming damaged or spilling the contents of the tank due to movement of the jack. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

Diesel Exhaust Fluid (DEF) is a non-hazardous solution containing about 32.5% urea and 67.5% de-ionized water. DEF is sprayed into the exhaust stream of diesel vehicles in order to break down nitrous oxide (NOx or N2O) emissions from the vehicles. Using DEF, otherwise dangerous NOx emissions are converted to harmless nitrogen and water by being converted to ammonia via a catalyst. Within a diesel vehicle (such as a semi-truck) DEF is contained within in a DEF tank that is separate from the diesel fuel tank. DEF is consumed at roughly 3% of diesel fuel consumption, therefore around 3 gallons of DEF are required for every 100 gallons of diesel.

Due to the of size of the fuel tanks on a semi-truck or other large diesel vehicle, most large diesel vehicles are equipped with a DEF tank that can hold 20+ gallons of DEF. Further, DEF itself weighs about 9 lbs. per gallon, so a typical DEF tank will contain about 180+ pounds of the fluid, not taking into account the weight of the metal tank itself. For maintenance purposes, DEF tanks may need to be removed from the side of a semi-truck or other diesel vehicle for maintenance or replacement. However, due to the weight, shape and location of a DEF tank on most vehicles the tank is incredibly difficult to remove and/or replace by hand. As a result, many users resort to using existing hydraulic jacks known in the art to aid in removing or replacing a DEF tank. However, existing hydraulic jacks are not optimized for receiving or supporting a DEF tank, due to the irregular curvature and slender proportions of most conventional DEF tanks. As a result, a DEF tank may fall from a jack while a user is attempting to remove or replace the tank. This is undesirable, as a damaged DEF tank may not function properly, may cause spill and as a result of drop damage the tank must be replaced. Further, DEF tanks may move, tilt or sway while on the top surface of a jack, such that spillage of DEF can occur in the surrounding area. This is obviously undesirable and requires substantial cleanup. In addition, a user may not wish to permanently modify their hydraulic jack (which they may use for other tasks) to receive a DEF tank adequately and to protect against droppage or spillage of the tank.

Therefore, there exists a long-felt need in the art for an adapter for a hydraulic jack that can be used to more easily remove and/or replace a DEF tank. There also exists a long-felt need in the art for a DEF tank hydraulic jack adapter plate that can be attached to an existing hydraulic jack, to allow the jack to easily receive a DEF tank for removal or replacement. In addition, there exists a long-felt need in the art for a DEF tank hydraulic jack adapter plate that can be attached to an existing hydraulic jack. The adapter plate is removable such that the hydraulic jack can retain its original configuration and function as needed when not being used on a DEF tank. Finally, there exists a long-felt need in the art for a DEF tank hydraulic jack adapter plate that adequately secures the DEF tank to the adapter plate to prevent the dropping of the tank or spillage from the tank.

The subject matter disclosed and claimed herein, in one embodiment thereof, comprises a DEF tank hydraulic jack adapter plate. The adapter plate has a central load plate that can receive the bottom surface of a DEF tank and two L-shaped load plate brackets which are attached to the central load plate that further support the bottom and side surfaces of a DEF tank. The adapter plate also includes a pair of L-brackets and a pair of steel strap assemblies that can further be bolted to a DEF tank via suitable fasteners. As such, the L-brackets and steel strap assemblies ensure that the DEF tank remains secure upon the adapter plate and does not fall off the plate or spill during removal or use.

In this manner, the DEF tank hydraulic jack adapter plate of the present invention accomplishes all of the forgoing objectives and provides an effective device that aids a user in the removal or replacement of a DEF tank from a semi-truck or other diesel vehicle. The adapter further can be used with an existing hydraulic jack to save the user the expense of creating a separate, dedicated hydraulic jack that is only optimized to receive DEF tanks. Further, the design of the adapter plate ensures that a DEF tank cannot fall or spill while secured on the adapter plate during the replacement or removal process. Therefore, a user can fully utilize the capabilities of a hydraulic jack without having to worry about the DEF tank falling from the jack or spilling.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a DEF tank hydraulic jack adapter plate. The adapter has a central load plate that is attached to two L-shaped load plate brackets. Both the central load plate and the horizontal plates of each L-shaped load plate bracket also have a plurality of openings to allow the adapter to be secured to the top surface of an existing hydraulic jack. Alternatively, the adapter may be fixedly attached (e.g., welded) to the top surface of an existing hydraulic jack. It is further contemplated that the adapter is constructed from a durable steel or aluminum components such that is does not deform under the weight of a DEF tank.

The vertical plate portion of each L-shaped load plate bracket has a plurality of openings that allow an L-shaped bracket and a plurality of steel strap assemblies to be attached to the adapter via a fastener. The fastener may include any combination of nuts, bolts, washer, spacers or other suitable fasteners. Further, the steel strap assemblies have two openings. The bottom opening receives a fastener to removably secure the strap assembly to the vertical plate of the L-shaped load bracket. The top continuous opening further receives a fastener that can also be received by an opening of each bracket that may have the side surface of a conventional DEF tank. Therefore, the fastener assembly travels through the frame arm and DEF tank bracket and is secured on the opposite side of the DEF tank bracket, such that the tank is secured to the frame arm and thus is secured to the adapter. To this effect, the tank is secure and cannot fall off the adapter or the jack, and cannot spill during movement of the jack.

Therefore, the improved DEF tank hydraulic jack adapter plate of the present invention is particularly advantageous as it allows an individual to utilize a hydraulic jack to easily remove and/or replace a DEF tank. However, the adapter provides increased security and secures the tank such that the tank cannot fall off the jack or become damaged. Further, the adapter also limits the possibility of any of the contents of the DEF tank spilling due to falling or sudden movement while resting or moving on the jack.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a DEF tank hydraulic jack adapter plate device of the present invention attached to a hydraulic jack in accordance with the disclosed architecture;

FIG. 2 illustrates a side perspective view of one potential embodiment of the DEF tank hydraulic jack adapter plate device of the present invention while attached to a DEF tank in accordance with the disclosed architecture;

FIG. 3 illustrates a rear perspective view of one potential embodiment of the DEF tank hydraulic jack adapter plate device of the present invention while attached to a DEF tank in accordance with the disclosed architecture;

FIG. 4 illustrates a perspective view of one potential embodiment of a frame arm of a strap assembly of the DEF tank hydraulic jack adapter plate device of the present invention in accordance with the disclosed architecture; and

FIG. 5 illustrates a schematic view of a truck having a DEF tank attached to one potential embodiment of the DEF tank hydraulic jack adapter plate device of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an adapter for a hydraulic jack that can be used to more easily remove and/or replace a DEF tank from a large diesel vehicle. There also exists a long-felt need in the art for a DEF tank hydraulic jack adapter plate that can be attached to existing hydraulic j acks, to allow the jack to more easily receive a DEF tank for removal or replacement. The adapter plate can be attached to the jack, and is removable such that the hydraulic jack can retain its original structure and function as needed. Finally, there exists a long-felt need in the art for a DEF tank hydraulic jack adapter plate that adequately secures the DEF tank to the adapter plate to prevent the dropping of the tank or spillage from the tank, which further allows an individual to fully utilize a hydraulic jack without having to worry about damaging, dropping or spilling the tank during the removal or replacement process.

The present invention, in one exemplary embodiment, is comprised of a DEF tank hydraulic jack adapter plate having a central load plate. The central load plate has two L-shaped load plate brackets attached along the sides. The load plate and the horizontal plates of each L-shaped load plate bracket may have a plurality of openings to allow the adapter to be secured to the top surface of an existing hydraulic jack. However, the adapter may also be fixedly-attached (e.g., welded) to the top surface of an existing hydraulic jack. It is also contemplated that the adapter is constructed from durable steel or aluminum components, such that it does not deform under the weight of a DEF tank.

The vertical plate of each L-shaped load plate bracket also includes a plurality of continuous openings that allow an L-shaped bracket and a plurality of steel strap assemblies to be attached to the adapter with a fastener. Further, the fastener may include any combination of nuts, bolts, washer, spacers and the like. The steel strap assemblies also include two openings, in which one opening receives a fastener assembly to removably secure the strap assembly to the vertical plate of the L-shaped load bracket. The second opening can also receive a fastener assembly that is received by an opening of each bracket of the side surface of a conventional DEF tank. Therefore, the fastener assembly travels through the frame arm and DEF tank bracket such that the DEF tank is secured to the frame arm and thus is secured to the adapter plate. To this effect, the tank is secure and cannot fall off of the adapter or jack or spill during movement of the jack that occurs while the tank is being removed or replaced.

Therefore, the improved DEF tank hydraulic jack adapter plate of the present invention is particularly advantageous, as it allows an individual to utilize a hydraulic jack to easily remove and/or replace a DEF tank. However, the adapter provides increased security such that the DEF tank cannot fall off of the jack and be damaged. Further, the adapter also limits the possibility of any of the contents of the DEF tank from spilling due to falling as a result of a sudden movement while resting or moving on a jack.

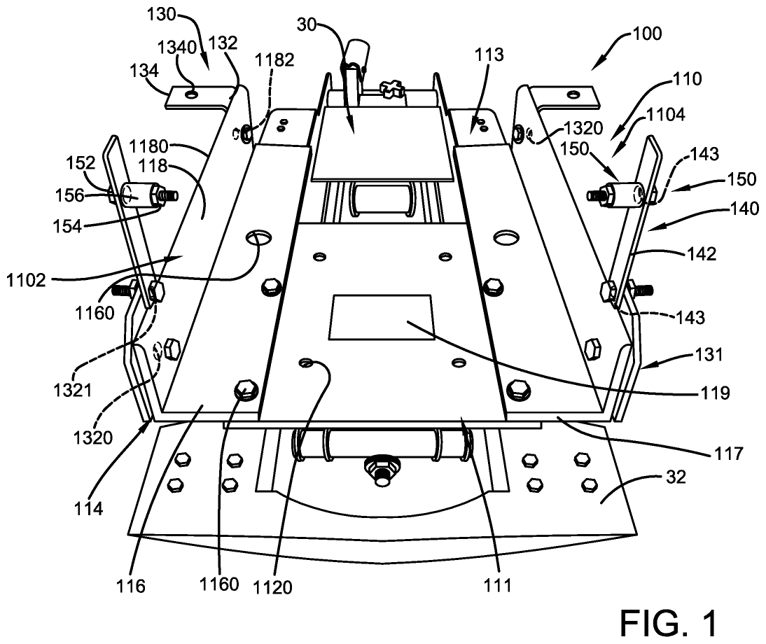

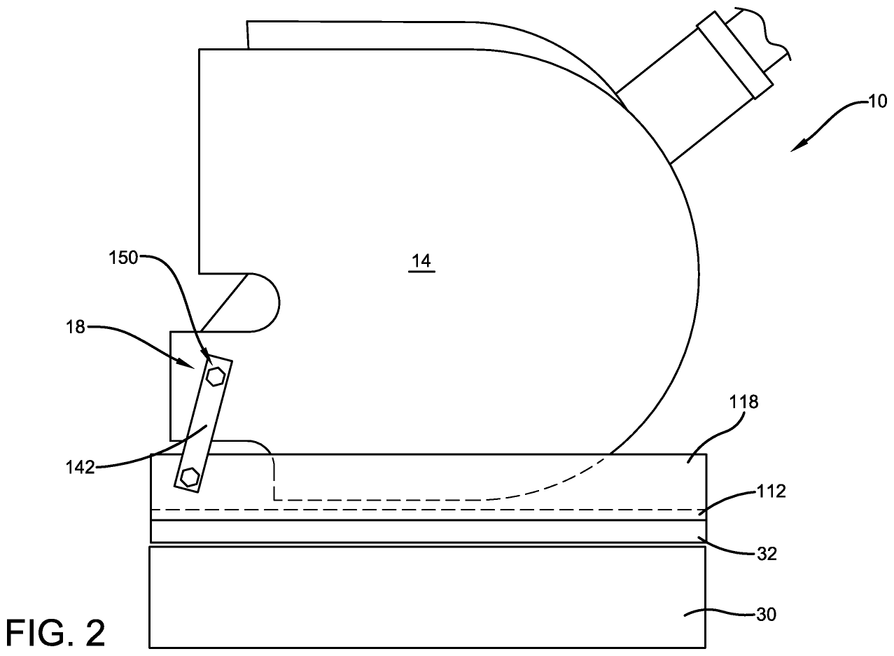

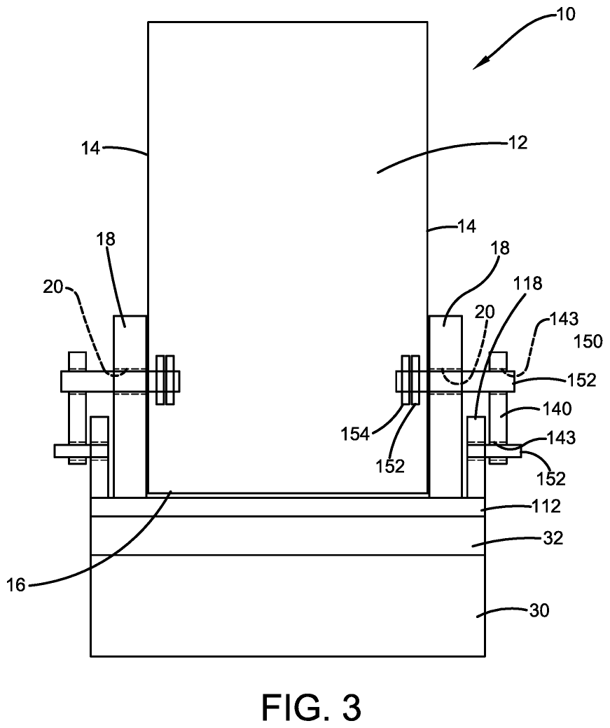

Referring initially to the drawings, FIG. 1 illustrates a perspective view of one potential embodiment of a DEF tank hydraulic jack adapter plate device 100 of the present invention attached to a hydraulic jack 30. The adapter 100 has a generally planar or flat plate body 110 having side edges 117 that includes a central load plate or portion 112, a pair of L-shaped load plate brackets 114, which extend generally upward from the plate body and at least one (but preferably two) steel strap assemblies 140. The L-shaped load plate brackets may be attached to the sides 117 of the central plate, or may overlap a portion of the central plate. The plate body 110 of the adapter 100 has a flat central load plate 112. The load plate 112 receives the bottom surface 16 of a DEF tank 10 (see FIG. 2) such that the tank 10 can rest or otherwise be securely seated on the adapter 10 during removal or replacement of the tank 10. The plate body 110 also has at least two L-shaped load plate brackets 114 that are fixedly (via a weld or other suitable attachment) or removably (via fasteners 1160) connected to and overlapping a portion of the load plate 112 on both the left and right sides 1102, 1104 of the load plate 112. The load plate brackets 114 each have a horizontal plate 116 and a vertical plate 118, which is disposed perpendicularly to the horizontal plate. When a tank 10 is secured to the adapter 100, the load plate brackets 114 contact the side surfaces 14 of a tank 10 (best seen in FIG. 3) to provide stability and to ensure that the tank 10 does not fall or become easily separated from the jack 30 or the contents of the tank 10 do not spill during movement of the jack 30. The central plate 112 may also include a sensor 119 which can be used to inform the operator of the vehicle that the DEF tank has become loose during operation of the vehicle.

The load plate 112 and horizontal plates 116 of the L-shaped load plate brackets 114 have a plurality of openings 1120, 1160 that allow the adapter 100 to be removably-secured to the top surface 32 of the frame of an existing hydraulic jack 30. The central plate is positioned adjacent to the hydraulic jack so that it does not interfere with operation of the jack. However, in one embodiment of the adapter 100, the adapter 100 may be welded to the top surface 32 of the frame of an existing jack 30 such that it becomes permanently attached to the top surface 32. Therefore, an embodiment containing a fixedly-attached adapter 100 may also include a hydraulic jack 30 as part of the invention. In differing embodiments, it is also contemplated that the plate body 110 and its components may be manufactured from any suitable durable metal, such as but not limited to: stainless steel, steel, aluminum, metal alloys and high-strength composites such as a carbon fiber composite combinations.

The vertical plate 118 of each L-shaped load plate bracket 114 may further contain a plurality of mechanisms to allow the adapter 100 to be fastened to a DEF tank 10. One such mechanism includes at least one L-bracket 130 that may be fixedly-attached (e.g., welded) to the outside surface 1180 of the vertical plate 118 near the rear area 113 of the body 110. The bracket 130 has a vertical plate 132 and perpendicular horizontal plate 134. However, it is also contemplated that the vertical plate 132 of the L-bracket 130 and vertical plate 118 of the load plate bracket 114 may have a continuous opening 1182, 1320 such that a fastener assembly 150 may include any combination of a bolt 152, a nut 154, and a washer or spacer 156 may be used to removably secure the bracket 130 to the vertical plate 118. Further, the bracket 130 may also contain a horizontal plate 134 that also includes a continuous opening 1340 that can be used to secure the adapter 100 to the bottom surface 16 near the front area 11 of a tank 10 via a fastener 150 that may include any combination of a bolt 152, a nut 154, and a washer or spacer 156.

The area of the vertical plate 118 near the front area 110 of the adapter 100 also preferably has at least one vertical bracket 131. Unlike the L-bracket 130, the vertical bracket 131 only has a vertical plate 132 with a second opening 1321 in addition to a first continuous opening 1320, in which the first opening 1320 allows a fastener assembly 150 which may be any combination of a bolt 152, a nut 154, and a washer or spacer 156 to removably secure the bracket 130 to the vertical plate 118. Accordingly, the second opening 1321 may receive a fastener assembly 150 of any combination of a bolt 152, a nut 154, and a washer or spacer 156 that allows a steel strap assembly 140 to attach to the plate 118. The assembly 140 further includes a frame arm 142 that has of two continuous openings 143. The bottom opening 143 allows the assembly 140 to attach to the plate 118 as noted and the top opening 143 can receive a fastener assembly 150 of any combination of a bolt 152, a nut 154, and a washer or spacer 156. As will be explained more fully below, each strap assembly 140 allows a bracket of a DEF tank 10 to be secured to the adapter such that the tank 10 cannot fall from the jack 30 or shift during movement of the jack 30.

FIG. 2 illustrates a side view of one potential embodiment of the DEF tank hydraulic jack adapter plate device 100 of the present invention while attached to a DEF tank 10 . As shown, most DEF tanks 10 have a bracket-like structure 18 on both side surfaces 14 of the tank 10. The bracket structure 18 typically has at least one opening 20. Accordingly, a DEF tank 10 can be positioned such that the front area 11 of the tank 10 is positioned near the rear area 113 of the adapter 100. Once a tank 10 is placed on the plate body 110, a user can then remove the fastener assembly 150 from the top continuous opening 143 of each steel strap assembly 140. As shown in FIG. 3, the bolt 152 of the fastener assembly 150 can then be placed through the top continuous opening 143 of the frame arm 142 and through the continuous opening 20 of the bracket 18 of the tank 10. Therefore, the tank 10 is further secured to the adapter 100 such that it cannot fall off of the jack 30. Further, the tank 10 cannot shift in position while the jack 30 moves, which could otherwise lead to the spillage of DEF from the tank 10.

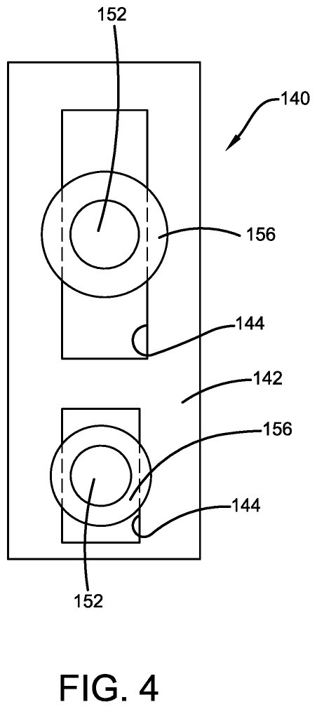

FIG. 4 illustrates a perspective view of one potential embodiment of a frame arm 142 of a strap assembly 140 of the DEF tank hydraulic jack adapter plate device 100 of the present invention. In one embodiment of the adapter 100, the strap assembly 140 frame arm 142 may have multiple openings in the form of slots 144, in addition to or in lieu of, round continuous openings 143 (as mentioned above). To this effect, the frame arm 142 can be better manipulated by allowing each fastener assembly 150 to be moved within the slot 144 (e.g., up or down) and then tightened. Therefore, the frame arm 142 can be positioned at a plurality of angles in order to accommodate any opening 20 or pattern or dimensions of a bracket 18 or side surface 14 of a tank 10. This adjustable configuration allows different-sized DEF tanks to be used with the present invention.

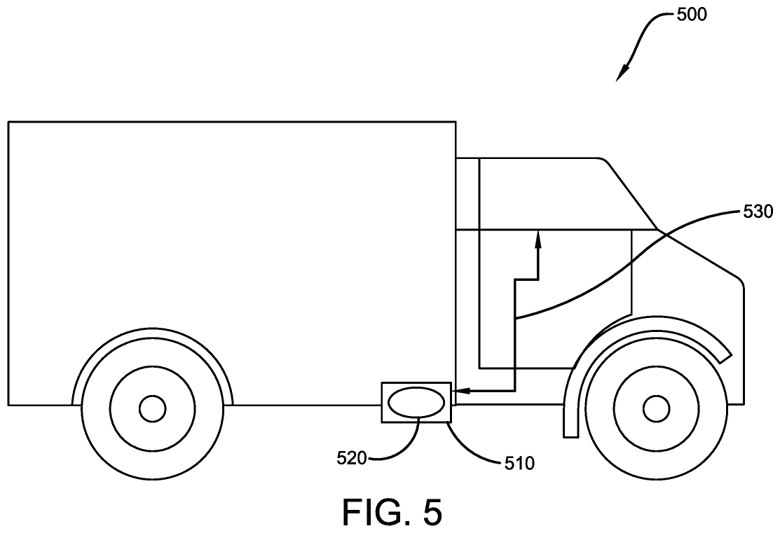

FIG. 5 provides a schematic of a truck 500 with a DEF tank 520 attached to the hydraulic jack adapter plate 510 of the present invention. The plate 510 is shown attached to the side of the truck to allow easy removal of the DEF tank 520 from the truck 500. The plate 510 may also have a sensor 119 (as shown in FIG. 1) which can be used to notify the operator 530 of the vehicle if the DEF tank has become loose from the plate.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “DEF tank hydraulic jack adapter plate”, “DEF tank hydraulic jack adapter plate device”, “adapter” and “device”, are interchangeable and refer to the DEF tank hydraulic jack adapter plate 100 of the present invention.

Notwithstanding the forgoing, the DEF tank hydraulic jack adapter plate 100 of the present invention and its various components can be of any suitable size and configuration as is known in the art without affecting the overall concept of the invention, provided that they accomplish the above-stated objectives. One of ordinary skill in the art will appreciate that the size, configuration, and material of the DEF tank hydraulic jack adapter plate 100 as shown in the FIGS. are for illustrative purposes only, and that many other sizes and shapes of the DEF tank hydraulic jack adapter plate 100 are well within the scope of the present disclosure. Although the dimensions of the DEF tank hydraulic jack adapter plate 100 are important design parameters for user convenience, the DEF tank hydraulic jack adapter plate 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An adapter plate for use with a DEF tank, the adapter plate comprising:
a plate comprised of a central portion and a pair of side edges, wherein the central portion is sized and configured to receive the DEF tank;
a pair of L-shaped load plate brackets are attached the pair of side edges of the plate, wherein each of the pair of L-shaped load plate brackets extend upwardly from the central plate; and
at least one supporting frame arm attached to the pair of L-shaped load plate brackets.

2. The adaptor plate as recited in claim 1, wherein two supporting frame arms are provided, and further wherein one supporting frame arm is attached to each of the L-shaped load plate brackets.

3. The adaptor plate as recited in claim 2, wherein the two supporting frame arms are attached to the DEF tank.

4. The adaptor plate as recited in claim 3, wherein each of the two supporting frame arms is attached to a bracket on a side of the DEF tank.

5. The adaptor plate as recited in claim 1, wherein the DEF tank may be removably secured to the plate through the use of fasteners extending through the at least one supporting frame arm.

6. The adaptor plate as recited in claim 1 further comprising a hydraulic jack and a frame, wherein the central plate is mounted to the frame so as to not interfere with the operation of the hydraulic jack.

7. The adaptor plate as recited in claim 1, wherein the pair of L-shaped load plate brackets are attached in an overlapping position of the pair of side edges of the plate.

8. The adaptor plate as recited in claim 1, wherein the central portion of the plate has a generally planar configuration.

9. The adaptor plate as recited in claim 1 further comprising a steel strap assembly for providing an adjustable mounting configuration to accommodate different sized DEF tanks.

10. The adaptor plate as recited in claim 9, wherein the steel strap assembly is connected to at least one of the pair of L-shaped load plate brackets.

11. A hydraulic jack and adapter plate combination comprising:
a hydraulic jack having a frame with a top surface;
an adapter plate comprising a central portion, a pair of side edges and a pair of vertical plates extending perpendicularly upward from the central portion; and
a pair of supporting arms, wherein one supporting arm of the pair of supporting arms is attached to each of the pair of vertical plates, and further wherein the pair of supporting arms allow for accommodation of a DEF tank of various dimensions.

12. The hydraulic jack and adapter plate combination as recited in claim 11 further comprising a pair of steel straps connected to the pair of vertical plates.

13. The hydraulic jack and adapter plate combination as recited in claim 12, wherein the pair of steel straps have a plurality of openings therein to allow adjustment to connect the adapter plate to the DEF tank.

14. The hydraulic jack and adapter plate combination as recited in claim 11, wherein the pair of vertical plates are two L-shaped plates that are fastened to the central portion of the adapter plate.

15. The hydraulic jack and adapter plate combination as recited in claim 13, wherein the pair of steel straps are attached to a pair of sides of the DEF tank.

16. The hydraulic jack and adapter plate combination as recited in claim 11, wherein the central plate is mounted to the frame so as to not interfere with the operation of the hydraulic jack.

17. The hydraulic jack and adapter plate combination as recited in claim 11 further comprising a sensor to detect whether the DEF tank is loose.

18. A vehicle having an adaptor plate for a DEF tank comprising;
a diesel vehicle having a frame;
an adapter plate attached to the frame of the diesel vehicle, wherein the adapter plate is fastened to a frame of a hydraulic jack;
the DEF tank secured to the adapter plate; and
a sensor to detect whether the DEF tank is properly secured to the adapter plate.

19. The vehicle having an adaptor plate for a DEF tank as recited in claim 18, wherein the adapter plate is comprised of a central portion and two L-shaped support frames attached to a pair of edges of the central portion.

20. The vehicle having an adaptor plate for a DEF tank as recited in claim 19 further comprising a pair of steel straps connected to the two L-shaped support frames, wherein the pair of steel straps are used to hold the DEF tank to the adapter plate.
